(19) United States
(12) Patent Application Publication
(10) Pub. No.: US 2008/0134350 A1
(43) Pub. Date: Jun. 5, 2008

(54) Computer chassis for improved security and connectivity of secured items

(75) Inventor: Michael Hall, Santa Cruz, CA (US)

Correspondence Address: MURABITO, HAO & BARNES, LLP, TWO NORTH MARKET STREET, THIRD FLOOR, SAN JOSE, CA, 95113, US

(73) Assignee: 55 Consultants, Inc.

(21) Appl. No.: 11/899,485

(22) Filed: Sep. 5, 2007

Related U.S. Application Data
(63) Continuation of application No. 11/639,984, filed on Dec. 15, 2006.
Application No. 11/639,984 is a continuation-in-part of application No. 11/497,471, filed on Jul. 31, 2006.

(51) Int. Cl. G06F 21/00

(52) U.S. Cl. 726/34

(57) ABSTRACT

An apparatus for improving the security and connectivity of secured items. Embodiments provide an apparatus for securing items that comprises at least one interface for coupling the secured item to an external system, external device, external component, etc. The item may be coupled to the interface before placing the apparatus in a secured state, where a portion of the interface accessible from the outside of the apparatus provides electrical access to the item when in the secured state. Additionally, embodiments provide movement detection and alert mechanisms to enable the apparatus to detect movement thereof and generate an alert, thereby deterring theft of and/or tampering with the secured item.

### RELATED APPLICATIONS

This patent application is a continuation application of co-pending, commonly-owned U.S. patent application Ser. No. 11/639,984, filed on Dec. 15, 2006, entitled “APPARATUS FOR IMPROVED SECURITY AND CONNECTIVITY OF SECURED ITEMS,” naming Michael Hall as the inventor, having attorney docket number MACL-P002, which is a continuation-in-part application of co-pending, commonly-owned U.S. patent application Ser. No. 11/497,471, filed on Jul. 31, 2006, entitled “APPARATUS AND SYSTEM FOR IMPROVING COMPUTER SYSTEM SECURITY,” naming Michael Hall as the inventor, having attorney docket number MACL-P001, all of which are hereby incorporated herein by reference.

This patent application is related to co-pending, commonly-owned U.S. patent application Ser. No. ______, filed on Sep. 5, 2007, entitled “COMPUTER CHASSIS FOR IMPROVED SECURITY AND CONNECTIVITY OF SECURED ITEMS,” naming Michael Hall as the inventor, having attorney docket number MACL-P007, which is hereby incorporated herein by reference.

### BACKGROUND OF THE INVENTION

As technology advances, the capabilities and features of portable devices are continuing to increase. For example, portable devices will now store and play music, videos and other media. Hand-held computers now offer significant processing power rivaling desktop systems of the recent past. Additionally, portable storage devices continue to shrink in size, yet are capable of holding increasing amounts of information. As such, consumers are willing to pay higher and higher prices for these devices given their increasing utility.

As the value of these devices increases, the demand for adequate security measures is also increasing. Additionally, the increased reliance upon these devices is also fueling the desire for improved security. For example, many people use portable devices to plan their day, organize contacts, set reminders, check and send email, store confidential information, store and playback music, and the like. As such, theft or even unauthorized access to such devices may compromise day-to-day functionality, confidential information, etc.

When at work, at school or otherwise at a workstation, conventional security measures involve storing valuables in locked drawers. Although locking a valuable device in a drawer may provide security, it creates a serious inconvenience as the device must be removed for use. And given the frequency with which an average person leaves and returns to a workspace, repeated securing and unsecuring increases the likelihood that the device may unintentionally be left unsecured. Thus, conventional solutions are inconvenient and compromise both the device and the information contained thereon.

### SUMMARY OF THE INVENTION

Accordingly, a need exists for improved security measures for portable devices and the information contained thereon. Additionally, a need exists for a more convenient means of securing portable devices. Further, a need exists for a way to secure portable devices that reduces the number of times the device must be unsecured for use. Embodiments of the present invention provide novel solutions to these needs and others as described below.

Embodiments of the present invention are directed to an apparatus for improving the security and connectivity of secured items. More specifically, embodiments provide an apparatus for securing items (e.g., portable devices) that comprises at least one interface for coupling the secured item to an external system, external device, external component, etc. The item may be coupled (e.g., plugged in) to the interface before placing the apparatus in a secured state (e.g., to limit physical access to the item), where a portion of the interface accessible from the outside of the apparatus provides electrical access to the item (e.g., to communicate with the item, to provide power to the item, etc.) when in the secured state. Additionally, embodiments provide movement detection and alert mechanisms to enable the apparatus to detect movement thereof and generate an alert (e.g., audible alert, visual alert, etc.), thereby deterring theft of and/or tampering with the secured item.

In one embodiment, an apparatus for securing an item therein includes a housing including a surface for use with a cursor-positioning device for a computer system. The apparatus also includes a first member for sliding into the housing, the first member including a cavity for storage of the item therein. A lock mechanism is operable to place the first member in a secured state by limiting movement thereof with respect to the housing, the lock mechanism further for limiting physical access to the item when in the secured state. The apparatus also includes an interface for providing electrical access to the item when in the secured state.

In another embodiment, an apparatus for securing an item therein includes a housing including a surface for use with a cursor-positioning device for a computer system. The apparatus also includes a first member for sliding into the housing, the first member comprising a cavity for storage of the item therein. A lock mechanism is operable to place the first member in a secured state by limiting movement thereof with respect to the housing, the lock mechanism further for limiting physical access to the item when in the secured state. The apparatus also includes a movement detection component for detecting movement of the housing, the movement detection component further for generating a movement detection signal in response to the movement. An alert component is coupled to the movement detection component and operable to generate an alert in response to the movement detection signal.

And in yet another embodiment, an apparatus for securing an item includes a first member comprising a cavity for storage of the item therein. A second member is rotatably coupled to the first member, the second member including a surface for use with a cursor-positioning device for a computer system. A lock mechanism is operable to place the first and second members in a secured state by limiting movement of the second member with respect to the first member, the lock mechanism further for limiting physical access to the item when in the secured state. The apparatus may also include a switch for disabling a computer interface when the members are placed in the secured state, wherein the switch is coupled to the lock mechanism for changing a state thereof. The apparatus may include an interface for providing electrical access to the item when in the secured state. And in one embodiment, the apparatus may include a movement detection component for detecting movement of the first member with respect to a surface, the movement detection component further for generating a movement detection signal in response to the movement. An alert component coupled to the movement detection component may generate an alert in response to the movement detection signal.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a block diagram of an exemplary system for increasing computing security in accordance with one embodiment of the present invention.

FIG. 2 shows a block diagram of an exemplary security device for increasing computing security in accordance with one embodiment of the present invention.

FIG. 3 shows a block diagram of an exemplary computer system in accordance with one embodiment of the present invention.

FIG. 4 shows a perspective view of an exemplary security device with a top cover in accordance with one embodiment of the present invention.

FIG. 5 shows a perspective view of an exemplary security device without a top cover in accordance with one embodiment of the present invention.

FIG. 6 shows a perspective view of an exemplary security device in a secured state with a wire-framed top cover in accordance with one embodiment of the present invention.

FIG. 7 shows a perspective view of an exemplary lock mechanism of a security device in accordance with one embodiment of the present invention.

FIG. 8 shows a perspective view of an exemplary keyboard with an incorporated security device in accordance with one embodiment of the present invention.

FIG. 9 shows a perspective view of an exemplary display with an incorporated security device in accordance with one embodiment of the present invention.

FIG. 10 shows a perspective view of an exemplary computer system chassis with an incorporated security device in accordance with one embodiment of the present invention.

FIG. 11 shows a perspective view of an exemplary trackball input device with an incorporated security device in accordance with one embodiment of the present invention.

FIG. 12 shows a first perspective view of an exemplary security device with an exemplary external interface and an exemplary movement alert component in accordance with one embodiment of the present invention.

FIG. 13A shows a first perspective view of an exemplary movement alert component in accordance with one embodiment of the present invention.

FIG. 13B shows a second perspective view of an exemplary movement alert component in accordance with one embodiment of the present invention.

FIG. 14 shows a perspective view of the bottom of an exemplary security device with an exemplary movement alert component in accordance with one embodiment of the present invention.

FIG. 15 shows a second perspective view of an exemplary security device with an exemplary external interface and an exemplary movement alert component in accordance with one embodiment of the present invention.

FIG. 16 shows a perspective view of an exemplary security device in an unsecured state in accordance with one embodiment of the present invention.

FIG. 17 shows a perspective view of an exemplary security device in a secured state in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

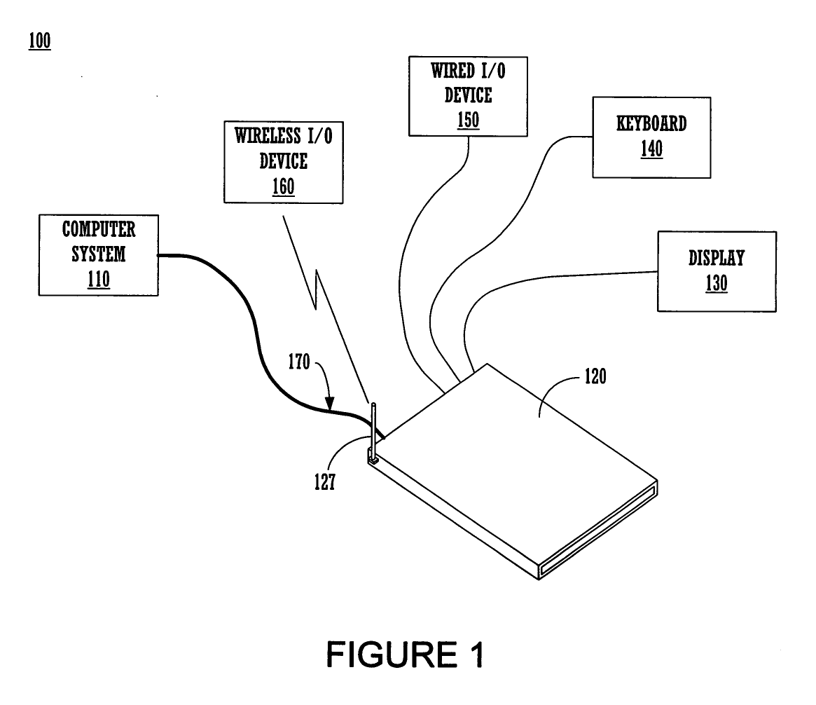

FIG. 1 shows a block diagram of exemplary system 100 for increasing computing security in accordance with one embodiment of the present invention. As shown in FIG. 1, computer system 110 is coupled to security device 120 via interface 170 for communicating with input/output (I/O) devices coupled thereto. For example, display 130, keyboard 140, wired I/O device 150 (e.g., wired computer mice, external storage devices, etc.) are shown coupled to device 120 for sending and receiving signals over wired interfaces, whereas wireless I/O device 160 (e.g., wireless computer mice, wireless external storage devices, etc.) is depicted as communicating wirelessly with device 120 via antenna 127. Alternatively, computer system 110 may communicate with device 120 via a wireless interface between an antenna (not shown) of computer system 110 and antenna 127 of device 120.

Given the positioning of device 120 in system 100 (e.g., between computer system 110 and a plurality of I/O devices), device 120 may effectively control access of coupled wired and wireless I/O devices to computer system 110. For example, the wireless interface coupling wireless I/O device 160 may be gated, switched, regulated, etc., thereby limiting access to computer system 110 via wireless I/O device 160. As such, when in a secured state, device 120 may reduce the ability of an unauthorized user to use, communicate with, and/or access information (e.g., stored within computer system 110, wired I/O device 150, wireless I/O device 160, etc.) or other functionality of computer system 110.

Alternatively, device 120 may regulate I/O interfaces to enforce privilege levels for accessing computer system 110, where a higher privilege level permits greater access to information and functionality of computer system 110. Thus, by switching and/or regulating wireless interfaces coupling wireless I/O devices to computer systems, device 120 effectively increases the security of the computer systems to protect confidential information stored within and/or accessible via the coupled computer systems.

Similarly, device 120 may gate, switch, regulate, etc. any wired interface coupling a wired I/O device (e.g., 150) to effectively limit unauthorized access. For example, the interfaces connecting display 130 and/or keyboard 140 to computer system 110 may be switched off during a secured state, thereby preventing users from inputting commands and/or viewing the results of those commands. Alternately, such interfaces may be regulated by device 120 to limit user interaction with computer system 110 (e.g., to establish user privilege levels, etc.). Thus, by switching and/or regulating wired interfaces coupling wired I/O devices to computer systems, device 120 effectively increases the security of the computer systems to protect confidential information stored within and/or accessible via the coupled computer systems.

Although computer system 110 is depicted in FIG. 1 as a desktop chassis, it should be appreciated that computer system 110 may alternatively be a laptop, personal digital assistant (PDA), cellular phone, embedded system, or the like. Additionally, device 120 may couple additional and/or different I/O devices from those depicted in FIG. 1. Further, although certain I/O devices are depicted as communicating via wired or wireless interfaces, it should be appreciated that the I/O devices may utilize alternative interfacing methods in other embodiments (e.g., keyboard 140 may be a wireless keyboard, etc.).

Although device 120 is depicted as a separate unit from computer system 110, it should be appreciated that device 120 may be integrated with computer system 110 in other embodiments. Similarly, although device 120 is depicted as a separate unit from display 130, keyboard 140, wired I/O device 150 and wireless I/O device 160, it should be appreciated that device 120 may be integrated with one or more of these I/O devices in other embodiments.

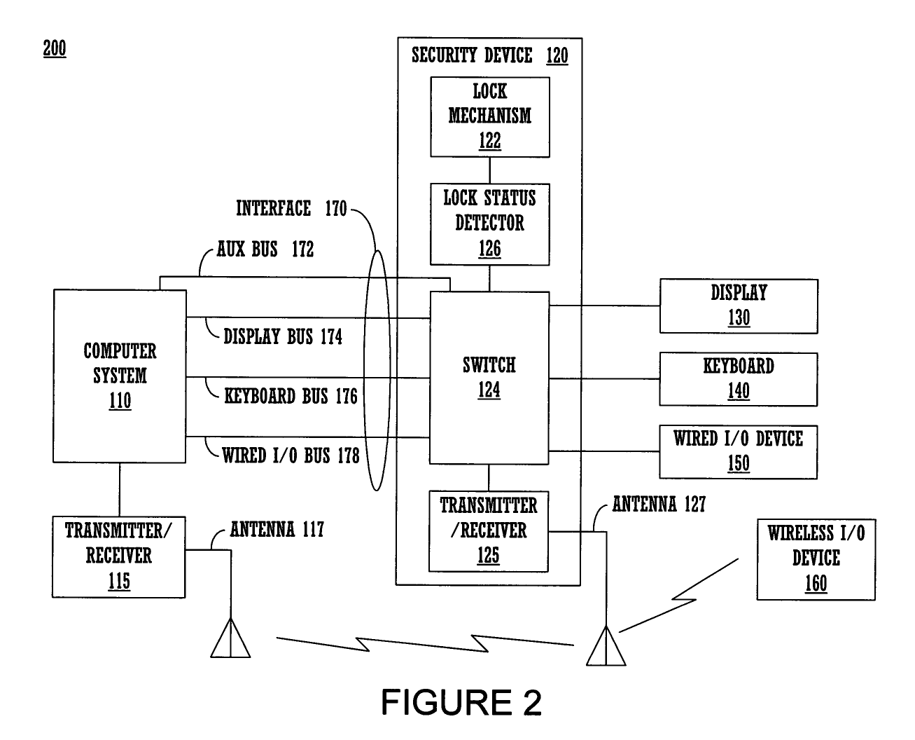

FIG. 2 shows block diagram 200 of an exemplary security device for increasing computing security in accordance with one embodiment of the present invention. As shown in FIG. 2, security device 120 is disposed between computer system 110 and a plurality of wired and wireless I/O devices (e.g., display 130, keyboard 140, wired I/O device 150 and wireless I/O device 160). As such, device 120 may effectively increase the security of computer system 110 by regulating access to confidential information stored within and/or accessible to computer system 110 (e.g., stored within computer system 110, wired I/O device 150, wireless I/O device 160, etc.) and/or other functionality of computer system 110.

Device 120 may switch and/or regulate wired and wireless interfaces coupled thereto using optional switch 124. Switch 124 may utilize mechanical switching (e.g., relays, etc.) and/or digital switching to control access to computer system 110, where the switching and/or regulation is controlled by processors, logic and other circuitry. As such, switch 124 may switch both analog and digital interfaces, where switching of interfaces is accomplished with acceptable characteristics (e.g., impedance mismatch, interface length within device 120 to dampen reflections, etc.) to maintain signal integrity.

As shown in FIG. 2, switch 124 receives a plurality of inputs and outputs from I/O devices. For example, display 130, keyboard 140 and wired I/O device couple to switch 124. Additionally, transmitter/receiver 125 is coupled to switch 124 for sending and receiving signals via antenna 127. As such, switch 124 may receive signals from wireless devices (e.g., 160) utilizing various signaling techniques (e.g., Bluetooth, IEEE 802.11a, IEEE 802.11b, IEEE 802.11g, CDMA, WCDMA, TDMA, 3G, LMDS, MMDS, etc.).

Switch 124 may route the signals from coupled I/O devices over one or more interfaces coupling device 120 to computer system 110. For example, interface 170 may couple device 120 and computer system 110. Alternatively, device 120 and computer system 110 may be coupled via a wireless interface using wireless components of device 120 (e.g. transmitter/receiver 125 and antenna 127) and computer system 110 (e.g., transmitter/receiver 115 and antenna 117). And in other embodiments, one or more wireless and/or wired interfaces may be used to couple device 120 to computer system 110, thereby enabling communication between device 120 and computer system 110 for sending data (e.g., similar to that transferred via the wired buses depicted in FIG. 2), status updates, presence detection, or some other communicative task.

As shown in FIG. 2, interface 170 may comprise a plurality of dedicated and/or shared buses. For example, display bus 174 may transmit analog and/or digital signaling for communication with display 130. Keyboard bus 176 may enable analog and/or digital communication with keyboard 140. Additionally, analog and/or digital communication with wired I/O device 150 may be transmitted via wired I/O bus 178. Instead of utilizing a dedicated bus for individual wired devices, or when it is desirable to route wireless inputs to device 120 over wired interfaces to computer system 110, AUX bus 172 may pass signals from one or more wired or wireless I/O devices to and from computer system 110. Alternatively, AUX bus 172 may enable communication (e.g., using signaling in accordance with USB 2.0, PCI-Express, etc.) between device 120 and computer system 110 for status updates, presence detection, or some other communicative task.

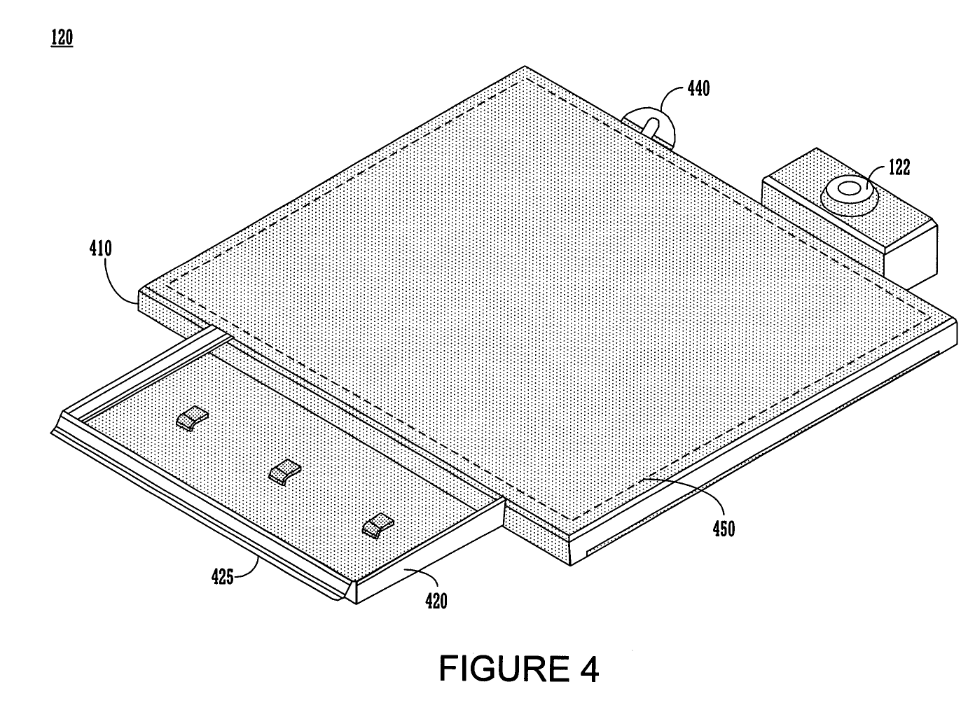

As more fully explained below with reference to FIGS. 4 through 10, device 120 includes mechanical lock mechanism 122 to secure items therein. As such, a user may place items comprising confidential information (e.g., password listings, username listings, portable storage devices containing confidential information and/or documents, etc.) into device 120 such that access to the items is limited when the lock mechanism is activated, thereby placing device 120 in a secured state. Lock mechanism 122 may comprise any known locking technology, where a user may toggle between one or more security states (e.g., corresponding to privilege levels) using a user interface associated with the locking mechanism. For example, the locking mechanism may be mechanical (e.g., key-actuated, combination, etc.), electrical (e.g., voice activated, etc.), optical (e.g., fingerprint activated, use eye-related recognition, etc.), or the like.

As shown in FIG. 2, lock status detector 126 couples to lock mechanism 122 and switch 124 such that switch 124 is updated when lock mechanism switches among security states. As such, detector 126 may access the lock status upon a change in state, and then relay this information to switch 124 to appropriately switch or regulate access to computer system 110. Although detector 126 is depicted as a separate component from lock mechanism 122 and switch 124, it should be appreciated that detector 126 may be integrated with either the lock mechanism or the switch. Moreover, where switch 124 is mechanical, it should be appreciated that detector 126 may be implemented as an element coupling the switch with the lock mechanism (e.g., a shaft, pulley system, etc.). As such, device 120 provides a convenient mechanism for securing items while simultaneously increasing the security of a coupled computer system by regulating access to confidential information accessible on or via the computer system.

Additionally, computer system 110 may include hardware and/or software capable of detecting the presence of device 120 to further increase the security of data stored within or accessible by computer system 110. The presence may be detected using one or more of the wired and/or wireless interfaces (e.g., 170, 172, 174, 176, 178, between antennas 117 and 127, etc.) coupling device 120 and computer system 110. As such, when the presence of the device is detected, access to such data may be increased (e.g., user privileges increased, more data made accessible, applications unlocked, etc.). However, when the presence of device 120 is not detected, access to such data may be reduced (e.g., user privileges decreased, less data made accessible, applications locked, etc.).

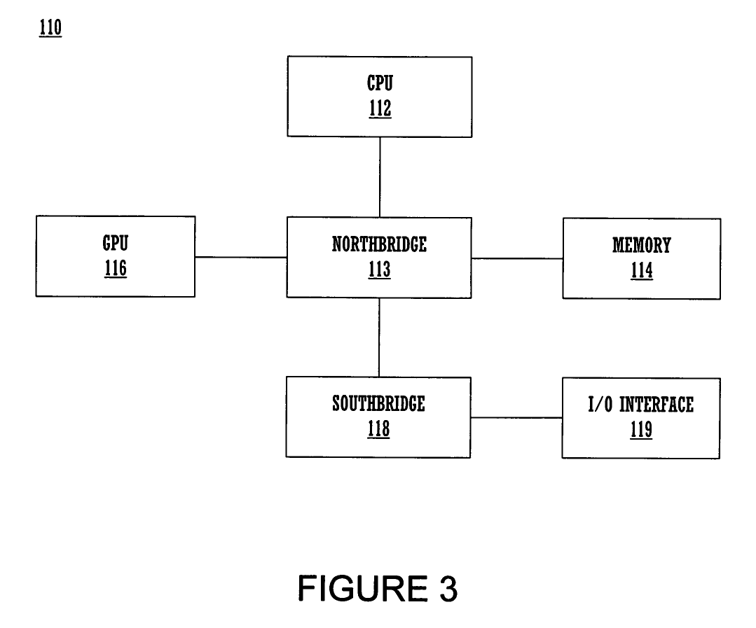

FIG. 3 shows a block diagram of exemplary computer system 110 in accordance with one embodiment of the present invention. As shown in FIG. 3, computer system comprises central processing unit (CPU) 112 for performing general processing operations (e.g., executing instructions, managing memory requests, etc.). Northbridge 113 is shown coupled to CPU 112 for managing access to memory 114, which may be detachably coupled to northbridge 113 (e.g., as a DIMM). Graphics processing unit (GPU) 116 is shown coupled to northbridge 113 for performing graphics processing operations, where GPU 116 may be detachably coupled with computer system 110 (e.g., as a component of a graphics card). Northbridge 113 couples to southbridge 118 such that components of computer system 110 may communicate with I/O devices via I/O interface 119, where I/O interface 119 is shown coupled to southbridge 118.

Although FIG. 3 depicts computer system 110 in a specific configuration, it should be appreciated that other computer systems may utilize different configurations. Moreover, computer system 100 may comprise more or less components depending upon the application. However, regardless of the configuration, computer system 110 should comprise a plurality of I/O interfaces (e.g., 119) for communication with other systems and devices (e.g., 120). The interfaces may be either wired or wireless, or both. As such, device 120 may protect confidential information stored within various components of computer system 110 (e.g., memory 114, registers of CPU 112, registers of northbridge 113, registers of southbridge 118, etc.) and/or within other memory devices coupled to computer system 110 (e.g., 150 and/or 160) by limiting access to computer system 110, and more specifically, to I/O interface 119.

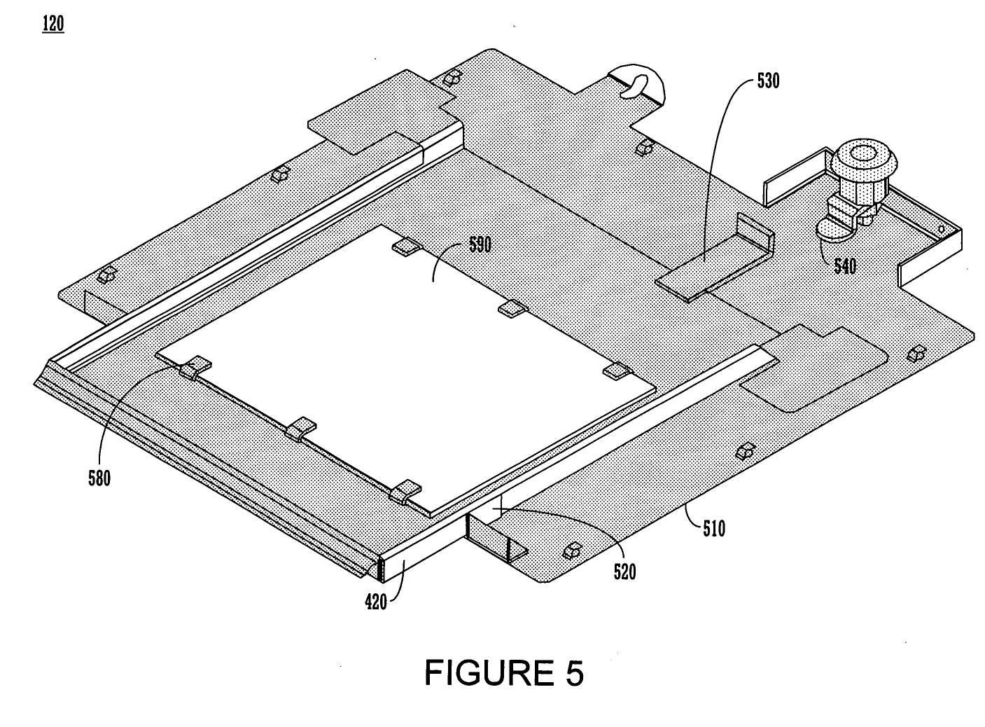

Now turning to FIGS. 4 and 5, FIG. 4 shows a perspective view of exemplary security device 120 with top cover 410 in accordance with one embodiment of the present invention, while FIG. 5 shows a perspective view of exemplary security device 120 without top cover 410 in accordance with one embodiment of the present invention. The housing of device 120 comprises top cover 410 disposed above base 510. Top cover 410 has a cutout sufficient to accommodate drawer 420, where drawer 420 may slide outward from device 120 such that objects may be placed within drawer 420 (e.g., item 590). When drawer 420 is slid into device 120, the state of lock mechanism 122 may be adjusted (e.g., by turning a key, etc.) such that lock arm 540 (shown coupled to lock mechanism 122) engages locking feature 530 (shown coupled to drawer 420).

Although FIGS. 4 and 5 depict lock mechanism 122 as a key-actuated lock, it should be appreciated that lock mechanism may be implemented in alternative fashions in other embodiments. For example, as discussed above with respect to FIG. 2, lock mechanism 122 may be mechanical (e.g., key-actuated, combination, etc.), electrical (e.g., voice activated, etc.), optical (e.g., fingerprint activated, use eye-related recognition, etc.), or the like. As such, once the state of the lock mechanism is changed (e.g., into a secured state), drawer 420 should be restrained within the housing such that items placed therein are secured. Although lock arm 540 and locking feature 530 may be implemented as depicted in FIG. 5, it should be appreciated that the drawer may be alternatively restrained in other embodiments.

Although not shown in FIGS. 4 and 5, device 120 may include provisions for routing of interfaces (e.g., 170) for coupling computer systems and I/O devices as described above with respect to FIGS. 1 and 2. As such, device 120 may include a plurality of ports, where the ports are coupled to a switch (e.g., 124). Cables may then be inserted into the ports for coupling computer systems and I/O devices. Alternatively, the interfaces could be plumbed directly into device 120 without ports (e.g., with cables), such that the interfaces could couple directly to the switch. The other end of the interface may then be coupled to computer systems and I/O devices. The switch may then be coupled with the lock mechanism (e.g., via detector 126) for automatic adjustment of the state of the switch in relation to the state of the lock mechanism (e.g., adjusted via user interaction).

Once in a secured state, access to items placed within drawer 420 is limited (e.g., concealed by top cover 410). As such, device 120 offers users a convenient mechanism to secure items within device 120 when leaving them unattended. Moreover, device 120 includes anchoring mechanism 440 for securing device 120 to a stationary or less-portable object (e.g., a desk, workstation, etc.). Although anchoring mechanism 440 is depicted in FIG. 5 as integrated with base 510, it may be attached to other portions of device 120 (e.g., top cover 410). Additionally, anchoring mechanism 440 may be detachably coupled to device 120, thereby allowing users to customize device 120 while still providing security (e.g., by preventing the anchoring mechanism from being detached from the outside of device 120). Thus, anchoring mechanism 440 provides additional security for items secured within device 120.

As shown in FIGS. 4 and 5, drawer handle 425 is coupled to a portion of drawer 420 such that a user may access the handle to slide drawer 420 from device 120. A plurality of front drawer guides 520 may be coupled to base 510 to guide drawer 420 when sliding it with respect to base 510 and top cover 410. Although guides 520 are depicted as flat members, it should be appreciated that they may be implemented using other shaped (e.g., round pegs, etc.) in other embodiments. Alternatively, the guides may be coupled to the drawer such that they track features in the base. Alternatively, the guides may be coupled to or integrated into the top cover.

Upon sliding the drawer out from device 120, items may be placed within drawer 420. For example, item 590 may be a listing of passwords and/or usernames, where item 590 is held down and organized by a plurality of item organizing features 580 (e.g., tabs coupled to drawer 420). Although not shown in FIGS. 4 and 5, item organizing features may assume other shapes and/or configurations. For example, the features may be clips, which may be formed from one member (e.g., using a material with spring-like properties) or more than one member. In a multi-member clip, at least one member may be a spring to provide clamping force for securing items within drawer 420. Additionally, vertical dividers may be used to prevent items (e.g., portable storage devices, writing instruments, etc.) from shifting during storage. Moreover, a combination of multiple types of features may be used to store and hold down items of different shapes and sizes.

As shown in FIG. 4, in this embodiment, the height of device 120 is substantially smaller than its length and width, such that top cover 410 forms surface 450 (as denoted by the dashed lines). Surface 450 is substantially flat such that peripheral devices (e.g., a computer mouse, other cursor directing devices, etc.) can be moved across the surface. As such, it should be appreciated that surface 450 may be coated such that the peripheral device (e.g., optical mice, laser mice, etc.) is able to track its movement across surface 450. Similarly, it should be appreciated that an additional object (e.g., a rubber pad) may be placed on top of surface 450 to further customize the surface for interface with peripheral devices. Additionally, the peripheral devices may also be coupled with a switch of device 120 (e.g., 124) such that a user may conveniently limit access of an unauthorized user to a coupled computer system via the peripheral device as discussed above with respect to FIGS. 1 and 2.

Although device 120 is depicted in FIGS. 4 and 5 with a height substantially smaller than its length and width, it should be appreciated that the height is sufficient to allow the placement of objects into drawer 420 and the closing of drawer 420 such that the objects may be secured within device 120. In other embodiments, the height of device 120 and/or drawer 420 may be varied to allow the securing of larger objects. Additionally, top cover 410, base 510 and/or drawer 420 may be modified to accommodate larger objects such that drawer 420 protrudes outside top cover 410 and/or base 510.

Furthermore, device 120 may be formed from a variety of materials to provide varying costs, levels of security, and design choices. For example, the housing of device 120 may be formed from sheet metal. Alternatively, an impact resistant plastic (e.g., polycarbonate, acrylonitrile butadiene styrene, a PC/ABS combination, etc.) may be used. Moreover, the material may be colored (e.g., by the use of colored material, colored coating, etc.), where such color scheme may coordinate and/or match that of a coupled device or system (e.g., 110, 130, 140, 150, 160, etc.).

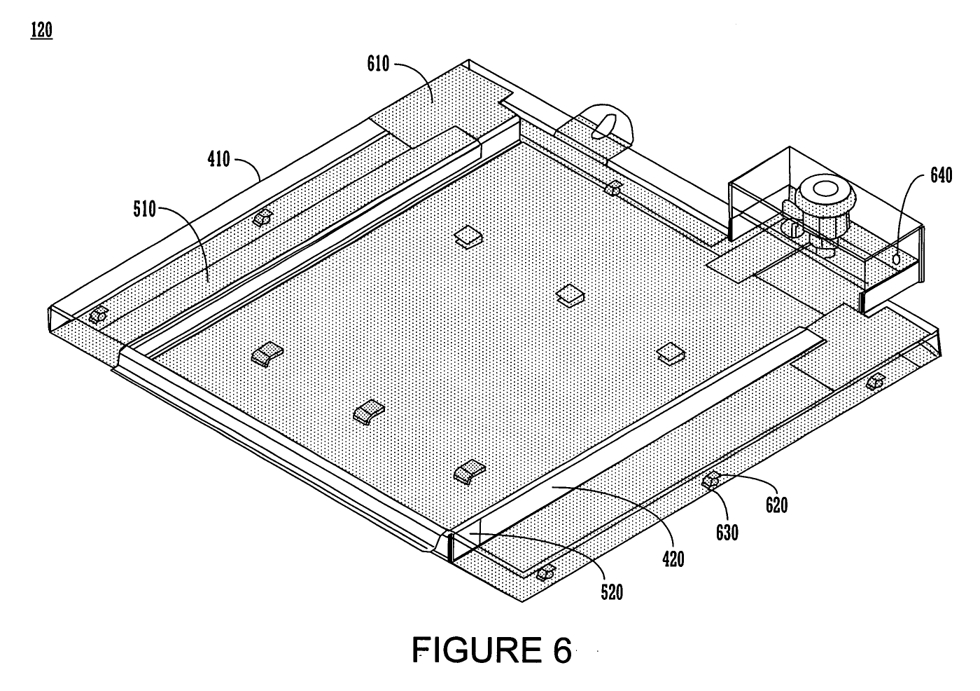

FIG. 6 shows a perspective view of exemplary security device 120 in a secured state with a wire-framed top cover in accordance with one embodiment of the present invention. As shown in FIG. 6, top cover 410 (shown as a wire-frame) is coupled to base 510 via top cover hold-down features 620. Features 620 engage hold-down feature engagement slots 630, where slots 630 are integrated into top cover 410. After engaging the features and slots, top cover 410 may be fastened to base 510 by aligning top cover fastening points 640 integrated into base 510 with corresponding features in the top cover. Once aligned, a fastener (e.g., rivet, screw, etc.) may be inserted and set to fasten the top cover to the base.

Although a specific manner of engaging and fastening the top cover and base are depicted in FIG. 6, it should be appreciated that other means may be used. For example, the top cover and base may snap together with locking features (e.g., snaps, tabs, etc.) and corresponding receptacle features. Alternatively, other coupling mechanisms (e.g., hinges, tabs, etc.) may be used in conjunction with locking features to minimize the number of fastening features. And in other embodiments, other secondary operations (e.g., heat staking, ultrasonic welding, etc.) may be performed to secure the top cover and base to one another.

As shown in FIG. 6, drawer 420 utilizes both front drawer guides 520 and rear drawer guides 610 to restrain movement to a substantially straight path when sliding the drawer with respect to top cover 410 and base 510. Guides 520 are integrated within top cover 410, while guides 610 are coupled to drawer 420. As such, guides 610 may track the inside wall of top cover 410 to guide the drawer.

Although specific front and rear drawer guide implementations are depicted in FIG. 6, it should be appreciated that other guides may be used. For example, front drawer guides 520 may be implemented as discussed above with respect to FIG. 5. Additionally, rear drawer guides 610 may be implemented similarly to the front drawer guides (e.g., alternatively coupled to the top cover, base, etc. as discussed above with respect to guides 520 in FIG. 5).

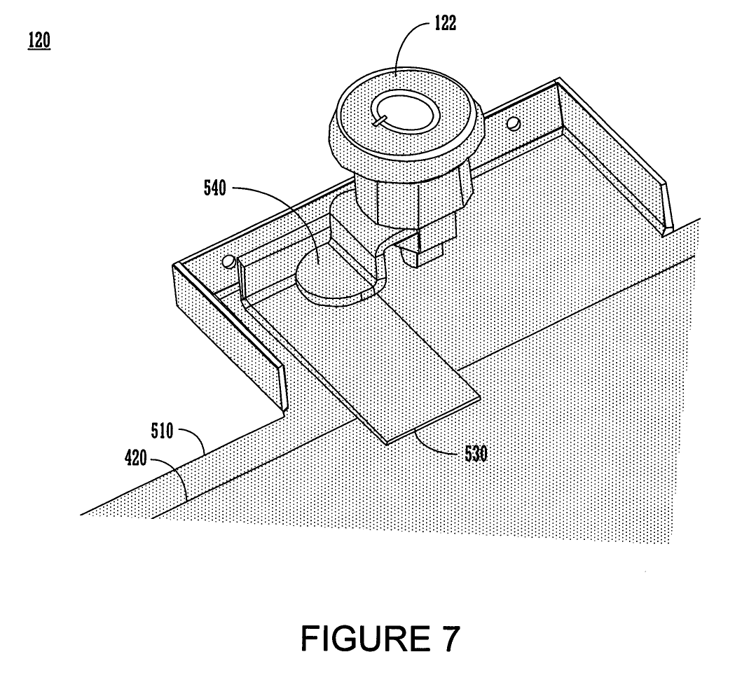

FIG. 7 shows a perspective view of an exemplary lock mechanism of security device 120 in accordance with one embodiment of the present invention. As shown in FIG. 7, lock arm 540 engages locking feature 530 coupled to drawer 420 when device 120 is placed in a secure state (e.g., by actuating lock mechanism 122). As such, lock arm 540 limits movement of drawer 420 with respect to base 510 such that items placed within drawer 420 are secured, where top cover 410 may limit access to the items. Furthermore, it should be appreciated that lock mechanism 122 is merely one example of many mechanisms that may be implemented within device 120 in other embodiments of the present invention as discussed above with respect to FIGS. 4 and 5.

Turning back to FIG. 6, guides 520 and 610 may work in conjunction to control the positioning of locking features of the drawer (e.g., 530) with respect to components of the lock mechanism that engage the drawer when in a secured state (e.g., lock arm 540). Locking feature 530 is thereby prevented from bypassing lock arm 540 such that drawer 420 may be opened when in a secured state. Thus, embodiments provide a convenient and effective means of securing items by limiting access thereto when device 120 is placed in a secured state.

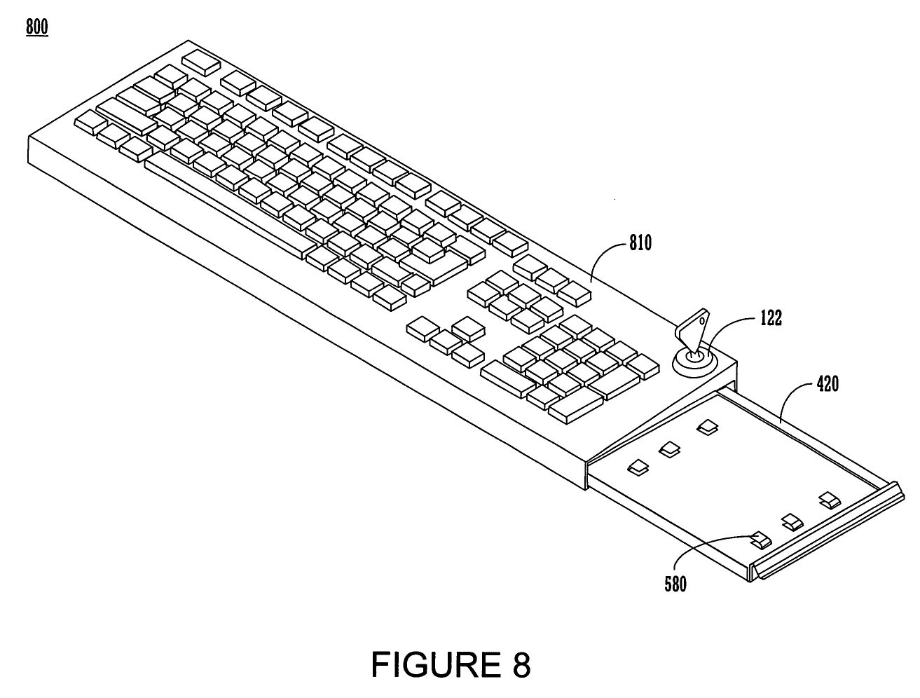

FIG. 8 shows a perspective view of exemplary keyboard 800 with an incorporated security device in accordance with one embodiment of the present invention. As shown in FIG. 8, keyboard 800 comprises housing 810 with a plurality of keys for generating signals sent to a computer system (e.g., 110) over a coupled interface (not shown), which may be wired and/or wireless. Drawer 420 is slidably-coupled with housing 810 such that items (e.g., password listings, portable storage devices, etc.) placed within the drawer and organized by item organizing features 580 may be secured when drawer 420 is positioned in a secured state. As such, security device 120 discussed above is effectively incorporated within keyboard 800.

As discussed above with respect to device 120, a secured state may be initiated by actuating lock mechanism 122 to restrict movement of drawer 420. Access to items placed within the drawer may therefore be limited when in the secured state. Moreover, changing the state of lock mechanism 122 may cause a switch (e.g., 124 via detector 126) to gate or regulate access to a coupled computer system (e.g., 110) via one or more interfaces coupling I/O devices to the switch. As such, computer interfaces may be coupled to keyboard 800 (e.g, via the routing of cables into housing 810, mounting connectors on housing 810, etc.) such that keyboard 800 is positioned between the computer system and a plurality of I/O devices (e.g., wired and/or wireless). Thus, keyboard 800 may provide users a convenient and effective mechanism to limit unauthorized access to confidential information stored within or accessible via coupled computer system.

In another embodiment, security mechanisms of the present invention may be alternatively implemented to provide additional functionality and flexibility. For example, instead of integrating device 120 within keyboard 800, device 120 may be coupled to housing 810 (e.g., as an extension to housing 810). As such, embodiments provide a keyboard and a mouse pad (e.g., surface 450) for coupling to a computer system with similar security mechanisms as described above. Alternatively, device 120 may be detachably coupled to housing 810 (e.g., to provide a mouse pad, security device, etc.), thereby allowing a user to control the placement of the device with respect to the keyboard for added convenience.

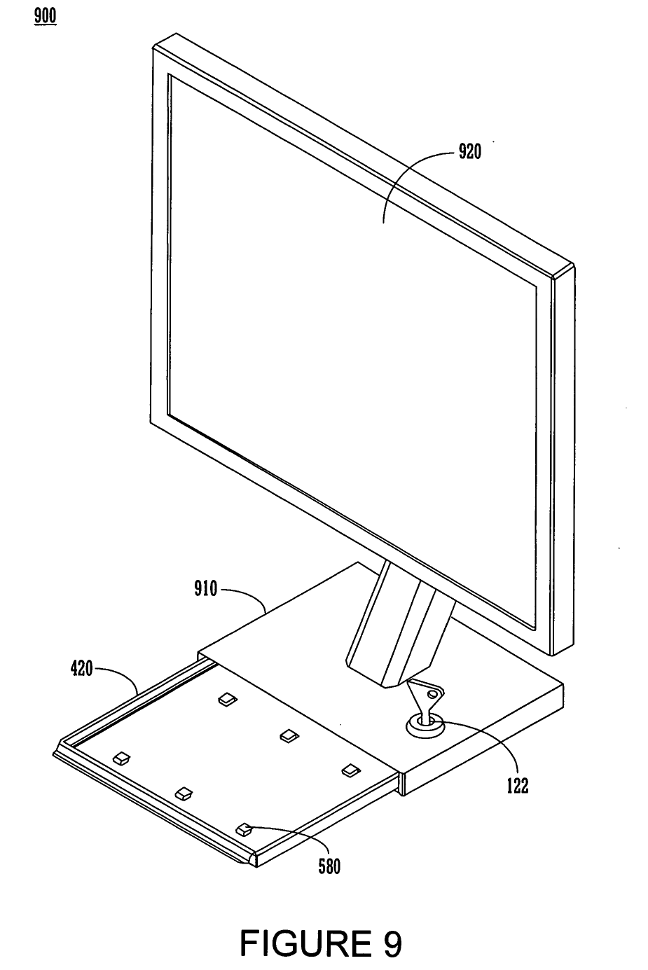

FIG. 9 shows a perspective view of exemplary display 900 with an incorporated security device in accordance with one embodiment of the present invention. As shown in FIG. 9, display 900 comprises housing 910 which supports display panel 920 for displaying computer generated signals communicated over an interface (not shown) coupling display 900 with a computer system (e.g., 110). Drawer 420 is slidably-coupled with housing 910 such that items (e.g., password listings, portable storage devices, etc.) placed within the drawer and organized by item organizing features 580 may be secured when drawer 420 is positioned in a secured state. As such, security device 120 discussed above is effectively incorporated within display 900.

As discussed above with respect to device 120, a secured state may be initiated by actuating lock mechanism 122 to restrict movement of drawer 420. Access to items placed within the drawer may therefore be limited when in the secured state. Moreover, changing the state of lock mechanism 122 may cause a switch (e.g., 124 via detector 126) to gate or regulate access to a coupled computer system (e.g., 110) via one or more interfaces coupling I/O devices to the switch. As such, computer interfaces may be coupled to display 900 (e.g., via the routing of cables into housing 910, mounting connectors on housing 910, etc.) such that display 900 is positioned between the computer system and a plurality of I/O devices (e.g., wired and/or wireless). Thus, display 900 may provide users a convenient and effective mechanism to limit unauthorized access to confidential information stored within or accessible via coupled computer system.

In another embodiment, security mechanisms of the present invention may be alternatively implemented to provide additional functionality and flexibility. For example, instead of integrating device 120 within housing 910, device 120 may be coupled to display panel 920 (e.g., disposed behind panel 920). Alternatively, device 120 may be detachably coupled to housing 910 (e.g., to provide a mouse pad, security device, etc.), thereby allowing a user to control the placement of the device with respect to the display for added convenience.

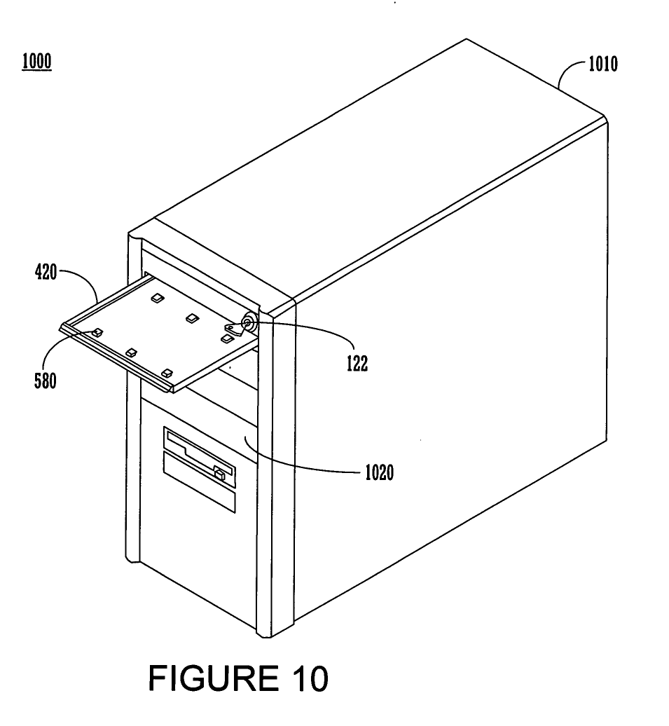

FIG. 10 shows a perspective view of exemplary computer system chassis 1000 with an incorporated security device in accordance with one embodiment of the present invention. As shown in FIG. 10, chassis 1000 comprises housing 1010 for mounting components of a computer system (e.g., 110 of FIGS. 1, 2 and/or 3), where the assembled computer system may include one or more interfaces (not shown) for communicating with coupled I/O devices. Drawer 420 is slidably-coupled with housing 1010 such that items (e.g., password listings, portable storage devices, etc.) placed within the drawer and organized by item organizing features 580 may be secured when drawer 420 is positioned in a secured state. As such, security device 120 discussed above is effectively incorporated within chassis 1000.

As discussed above with respect to device 120, a secured state may be initiated by actuating lock mechanism 122 to restrict movement of drawer 420. Access to items placed within the drawer may therefore be limited when in the secured state. Moreover, changing the state of lock mechanism 122 may cause a switch (e.g., 124 via detector 126) to gate or regulate access to the computer system (e.g., 110) via one or more interfaces coupling I/O devices to the switch. As such, computer interfaces may be coupled to chassis 1000 (e.g., via the routing of cables into housing 1010, mounting connectors on housing 1010, etc.) such that the switch is positioned between components of the computer system capable of accessing confidential information and a plurality of I/O devices (e.g., wired and/or wireless). Thus, chassis 1000 may provide users a convenient and effective mechanism to limit unauthorized access to confidential information stored within or accessible via the computer system.

In another embodiment, security mechanisms of the present invention may be alternatively implemented to provide additional functionality and flexibility. For example, instead of integrating device 120 within a dedicated region of housing 1010, device 120 may be implemented within any drive bay 1020 of chassis 1000 (e.g., fixedly coupled, removably coupled, etc.). The drive bays may conventionally be used to house storage devices (e.g., hard disk drives, CD-ROM drives, DVD-ROM drives, etc.), I/O connector panels, heat intake/exhaust vents, etc. As such, device 120 may exclusively occupy a drive bay of chassis 1000, or alternatively share a drive bay with one or more components of the computer system. Alternatively, device 120 may be detachably coupled to housing 1010 (e.g., to provide a mouse pad, security device, etc.), thereby allowing a user to control the placement of the device with respect to the chassis for added convenience.

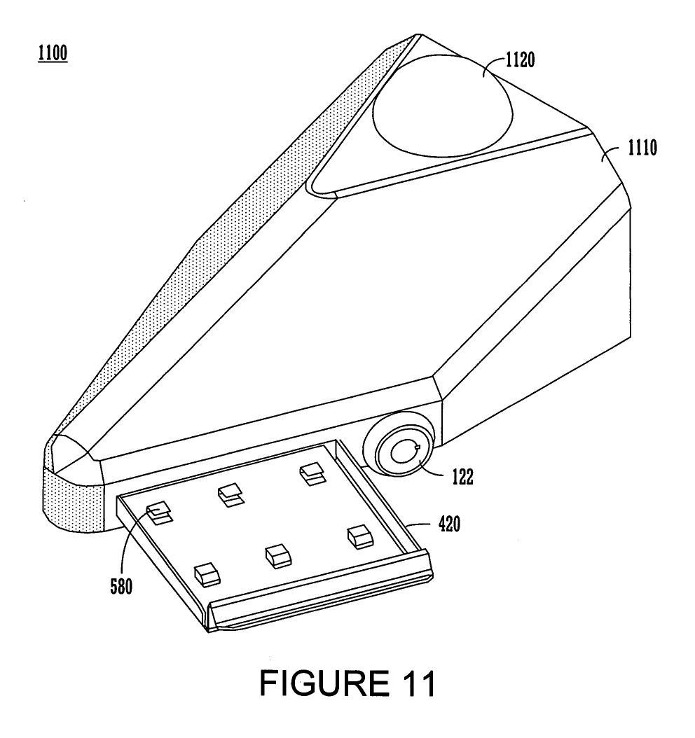

FIG. 11 shows a perspective view of exemplary trackball input device 1100 with an incorporated security device in accordance with one embodiment of the present invention. As shown in FIG. 11, input device 1100 comprises housing 1110 with integrated trackball 1120 for generating signals sent to a computer system (e.g., 110) over a coupled interface (not shown), which may be wired and/or wireless. Drawer 420 is slidably-coupled with housing 810 such that items (e.g., password listings, portable storage devices, etc.) placed within the drawer and organized by item organizing features 580 may be secured when drawer 420 is positioned in a secured state. As such, security device 120 discussed above is effectively incorporated within input device 1100.

As discussed above with respect to device 120, a secured state may be initiated by actuating lock mechanism 122 to restrict movement of drawer 420. Access to items placed within the drawer may therefore be limited when in the secured state. Moreover, changing the state of lock mechanism 122 may cause a switch (e.g., 124 via detector 126) to gate or regulate access to a coupled computer system (e.g., 110) via one or more interfaces coupling I/O devices to the switch. As such, computer interfaces may be coupled to input device 1100 (e.g, via the routing of cables into housing 1110, mounting connectors on housing 1110, etc.) such that input device 1100 is positioned between the computer system and a plurality of other I/O devices (e.g., wired and/or wireless). Thus, input device 1100 may provide users a convenient and effective mechanism to limit unauthorized access to confidential information stored within or accessible via coupled computer system.

In another embodiment, security mechanisms of the present invention may be alternatively implemented to provide additional functionality and flexibility. For example, instead of integrating device 120 within input device 1100, device 120 may be coupled to housing 1110 (e.g., as an extension to housing 1110). As such, embodiments may provide an input device and a mouse pad (e.g., surface 450) for coupling to a computer system with similar security mechanisms as described above. Alternatively, device 120 may be detachably coupled to housing 1110 (e.g., to provide a mouse pad, security device, etc.), thereby allowing a user to control the placement of the device with respect to the input device for added convenience.

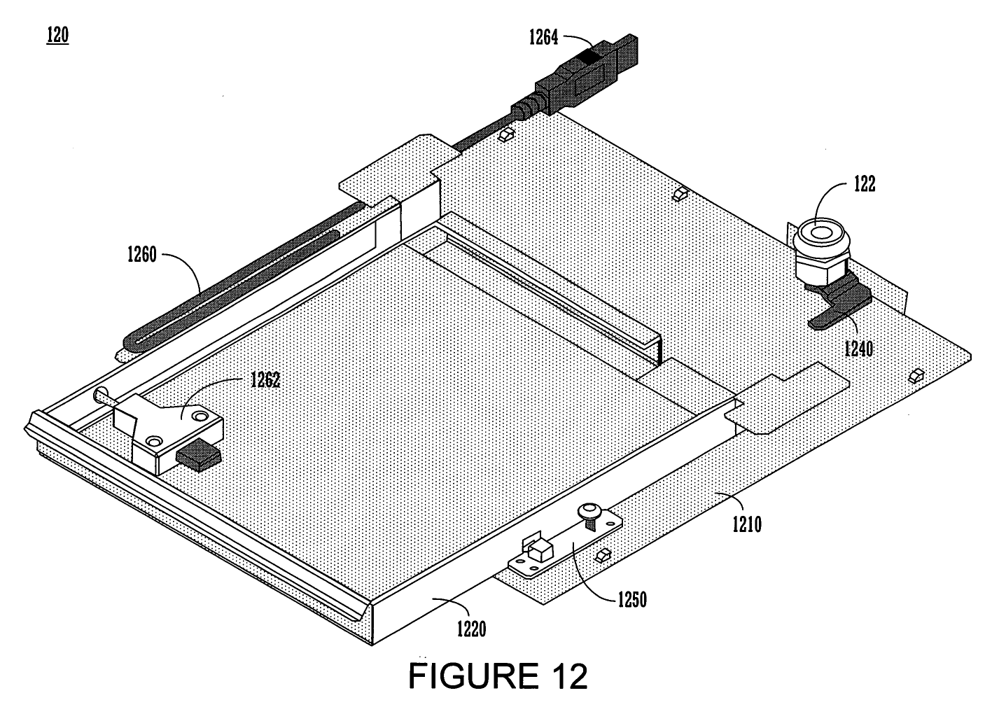

FIG. 12 shows a first perspective view of exemplary security device 120 with an exemplary external interface and an exemplary movement alert component in accordance with one embodiment of the present invention. As shown in FIG. 12, security device 120 may comprise drawer 1220 which slides with respect to base 1210 (e.g., as discussed above with respect to drawer 420 and base 510 of FIGS. 4-7). Drawer 1220 may be placed in a secured state by sliding the drawer into the security device housing (e.g., comprising base 510 and a top cover which is not shown in FIG. 12) and changing the state of lock mechanism 122 (e.g., as discussed above with respect to prior figures). In one embodiment, the lock arm 1240 may engage locking feature 1230 when lock mechanism 122 is placed in a secure state. As such, physical access to items placed in drawer 1220 may be limited when lock mechanism 122, and therefore device 120, is placed in a secured state.

As shown in FIG. 12, security device 120 comprises interface 1260 for coupling items placed within drawer 1220 to an external system, external device, external component, etc. For example, a portable device may be coupled to first interface plug 1262 and secured within device 120. Thereafter, interface 1260 may be used to communicate with, charge, or otherwise interact with (e.g., via second interface plug 1264) the portable device when device 120 placed in a secured state. Thus, interface 1260 provides electrical access to an item secured within device 120 when physical access to the secured item is limited.

Interface 1260 may comprise an interface bus in accordance with such standards as USB, USB 2.0, IEEE 1394, PCI-Express, SATA, Ethernet, etc., thereby enabling the transfer of media (e.g., music, video, etc.) and/or other data. The interface bus may also form a control bus for providing external control of a secured device. In one embodiment, an external controller (e.g., keys on a computer keyboard, a device with audio inputs and/or outputs, a device with visual inputs and/or outputs, etc.) may be coupled to interface 1260 to control, interact with and/or otherwise use an item secured in device 120. Alternatively, interface 1260 may comprise an analog signaling bus (e.g. for transferring analog signals (e.g., music, etc.) to and from a secured item. And in another embodiment, interface 1260 may provide power (e.g., alternative current (AC), direct current (DC), etc.) to an item secured within device 120, where the power may be used to operate a portion of the secured item, charge a power source of the secured item, etc.

Although FIG. 12 depicts only one interface (e.g., 1260), it should be appreciated that device 120 may comprise more than one interface in other embodiments. For example, when a portable computing system is secured within device 120, a power interface and at least one communication/interaction interface may be provided such that the portable computing device may be powered, charged, communicated with (e.g., when coupled to an external system, external device, external component, etc.) and/or interacted with (e.g., when coupled to an external display, external mouse, external keyboard and/or another external peripheral interface device). Alternatively, when a portable media device is secured within device 120, a power interface, at least one communication/interaction interface and/or at least one analog signaling interface (e.g., for coupling headphones, external speakers, etc.) may be provided such that the portable media device may be powered, charged, communicated with (e.g., to download media from the device, upload media to the device, etc.), interacted with (e.g., to enable playback of media, to alter playback of media, etc.), and/or otherwise used (e.g., to listen to music stored on the portable media device, to watch video or other media stored on the portable media device, etc.). And in another embodiment, when a portable storage device is stored within device 120, a power interface and at least one communication interface may be provided such that the portable storage device may be powered, charged and/or communicated with (e.g., to download information from the device, to upload information to the device, etc.).

Although FIG. 12 depicts interface 1260 with plugs (e.g., 1262 and 1264), it should be appreciated that other termination methods may be used. For example, one or more connectors (e.g., bulkhead connectors, etc.) may be mounted within device 120 and/or drawer 1220 (e.g., in place of or in addition to plug 1262 and/or plug 1264) for connecting devices to be secured and/or external systems, external devices, external components, or the like. As a further example, one or more transceivers may be mounted within device 120 and/or drawer 1220 (e.g., in place of or in addition to plug 1262) for wirelessly communicating with (e.g., in accordance with wireless interface standards such as Bluetooth, IEEE 802.11a, IEEE 802.11b, IEEE 802.11g, CDMA, WCDMA, TDMA, 3G, LMDS, MMDS, etc.) devices to be secured and/or external systems, external devices, external components, or the like.

As shown in FIG. 12, device 100 also comprises movement alert component 1250. Component 1250 can detect movement of device 100 (e.g., with respect to a surface on which device 120 is set, etc.). In response to detecting movement of device 120, component 1250 may activate an alert (e.g., an audible alert, visual alert, etc.) to deter theft of and/or tampering with items secured within device 120. As such, component 1250 provides additional security measures to device 120 in addition to those discussed previously.

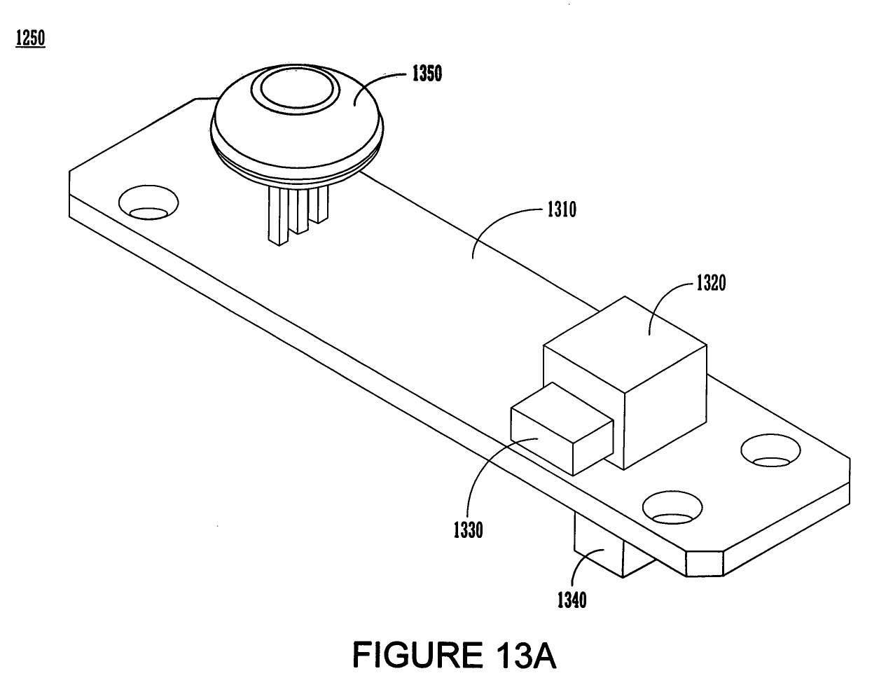

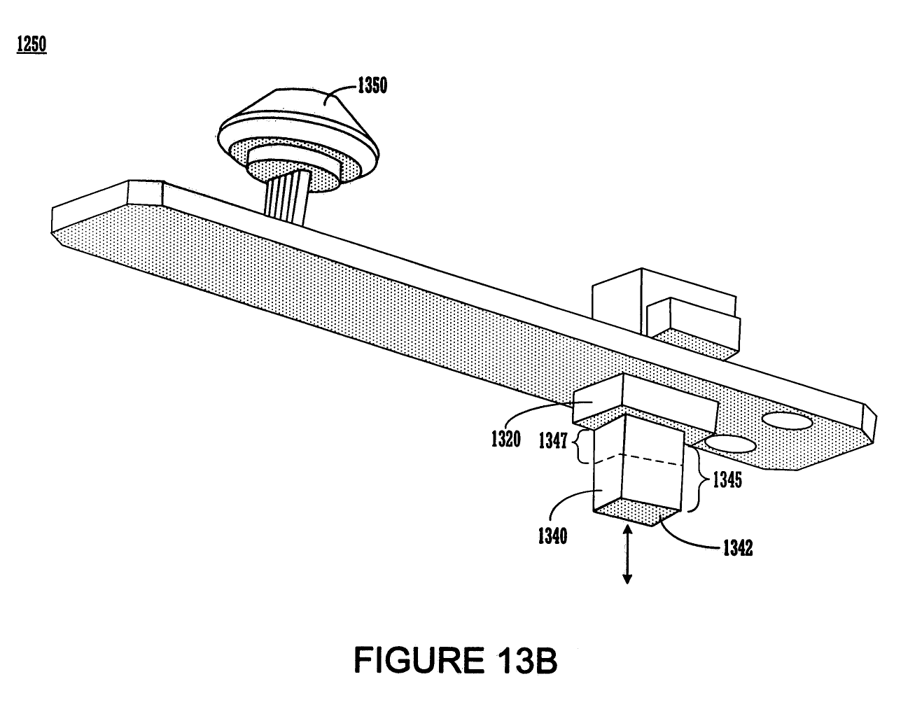

FIG. 13A shows a first perspective view of exemplary movement alert component 1250 in accordance with one embodiment of the present invention. As shown in FIG. 13A, both movement detection component 1320 and alert component 1350 are mounted to board 1310. Movement detection component 1320 comprises activation element 1340, which can move with respect to component 1320 (and therefore device 120 when component 1320 is mounted to device 120 as shown in FIG. 12). In one embodiment, activation element 1340 may function as a plunger, thereby extending and retracting in a linear fashion from component 1320. As such, when activation element 1340 comes into contact with a surface (e.g., a surface on which device 120 is placed), component 1320 can detect movement (e.g., lifting of device 120) with respect to the surface given the movement of activation element 1340.

In one embodiment, movement of activation element 1340 beyond a given threshold may trigger an alert as emitted by alert component 1350. The alert may be generated in response to a movement detection signal (e.g., generated by component 1320), where at least one electrical trace (e.g., within board 1310) couples components 1320 and 1350. Alternatively, components 1320 and 1350 may be mechanically coupled, where component 1320 may trigger an alert via a mechanical activation of component 1350.

In one embodiment, alert component 1350 may emit an audible alert. As such, component 1350 may comprise a speaker or other audio emission component. In another embodiment, component 1350 may emit a visual alert. As such, component 1350 may comprise a display, one or more lights, or other visual component. Alternatively, component 1350 may emit vibrations or other alerts. And in yet another embodiment, component 1350 may generate alert signals for transmission to an external system (e.g., computer system, building security system, etc.) for alert processing and/or generation.

As shown in FIG. 13A, component 1320 also comprises function element 1330 for changing a functional state of component 1320. In one embodiment, function element 1330 may be used (e.g., depressed) to reset movement alert component 1250, thereby halting an activated alert and preparing component 1320 for detection of another alert activation (e.g., via movement of element 1340). In another embodiment, function element may be used to change a movement detection characteristic (e.g., movement detection sensitivity, etc.) of component 1320, thereby providing flexibility and/or adjustability to the movement detection and/or alert generation capabilities of device 120.

FIG. 13B shows a second perspective view of exemplary movement alert component 1250 in accordance with one embodiment of the present invention. As shown in FIG. 13B, activation element 1340 comprises contact surface 1342 for making contact with surfaces (e.g., that which device 120 is placed upon), objects, etc., and in response to the contact, extending and/or retracting from component 1320 accordingly. For example, upon coming into contact with a surface, element 1340 may transition from a first state (e.g., represented by extended length 1345) to a second state (e.g., represented by retracted length 1347). Alternatively, when being released from contact with a surface, element 1340 may transition from the second state (e.g., represented by retracted length 1347) to the first state (e.g., represented by extended length 1345).

Component 1320 may comprise one or more switching or other sensory elements to detect movement of element 1340 (e.g., from length 1345 to length 1347, from length 1347 to length 1345, etc.). Additionally, component 1320 may comprise one or more logic and/or processing components to generate movement detection signals in response to a detected movement of element 1340, where such circuitry may interpret switching/sensory signals (e.g., produced by switches, sensors or other components for detecting movement of element 1340) and convey appropriate signals to component 1350 to generate alerts.

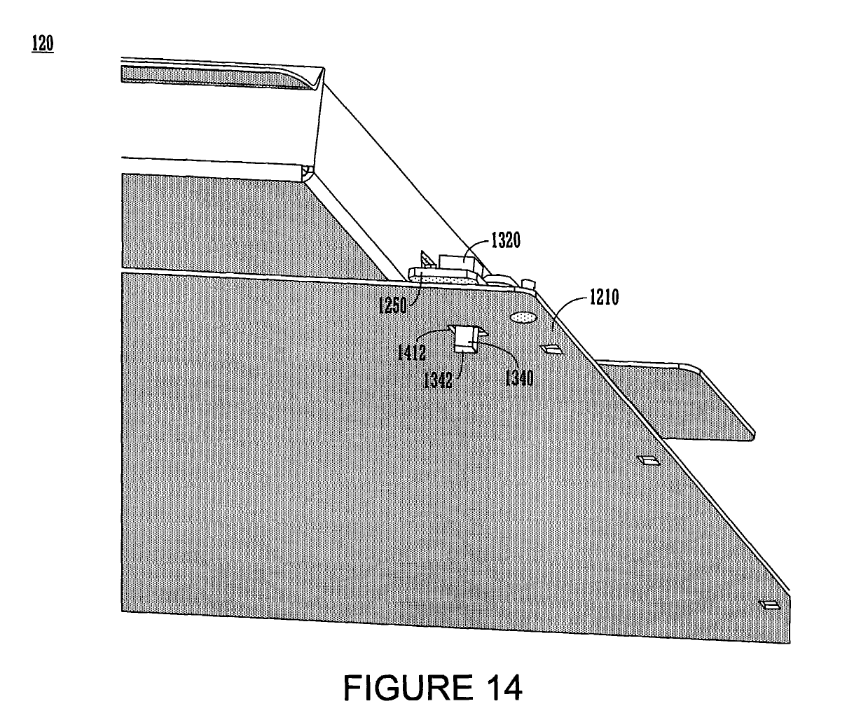

FIG. 14 shows a perspective view of the bottom of exemplary security device 120 with an exemplary movement alert component in accordance with one embodiment of the present invention. As shown in FIG. 14, when movement alert component 1250 is mounted to device 120, element 1340 may protrude from hole 1412 in base 1210. As such, a movement of device 120 may be detected by component 1320 when contact surface 1342 moves with respect to base 1210.

For example, placement of device 120 on a surface (e.g., that of a desk, workstation, etc.) may cause element 1340 to assume a state with retracted length 1347, where retraction of element 1340 is caused by the surface pushing element 1340 into component 1320 when device 120 is placed thereon. Thereafter, movement (e.g., lifting) of device 120 with respect to the surface may cause element 1340 to transition to a new state with extended length 1345. As such, component 1320 may detect the state transition of element 1340, thereby detecting movement of device 120 (e.g., with respect to the surface).

Although FIGS. 13A, 13B and 14 depict a movement detection component comprising a mechanical activation element (e.g., 1340), it should be appreciated that other motion detection components may be used in other embodiments. For example, in other embodiments, device 120 may comprise one or more accelerometers, ball-in-cage sensors, magnetometers, proximity sensors, motion detectors using light, or other movement detection sensors.

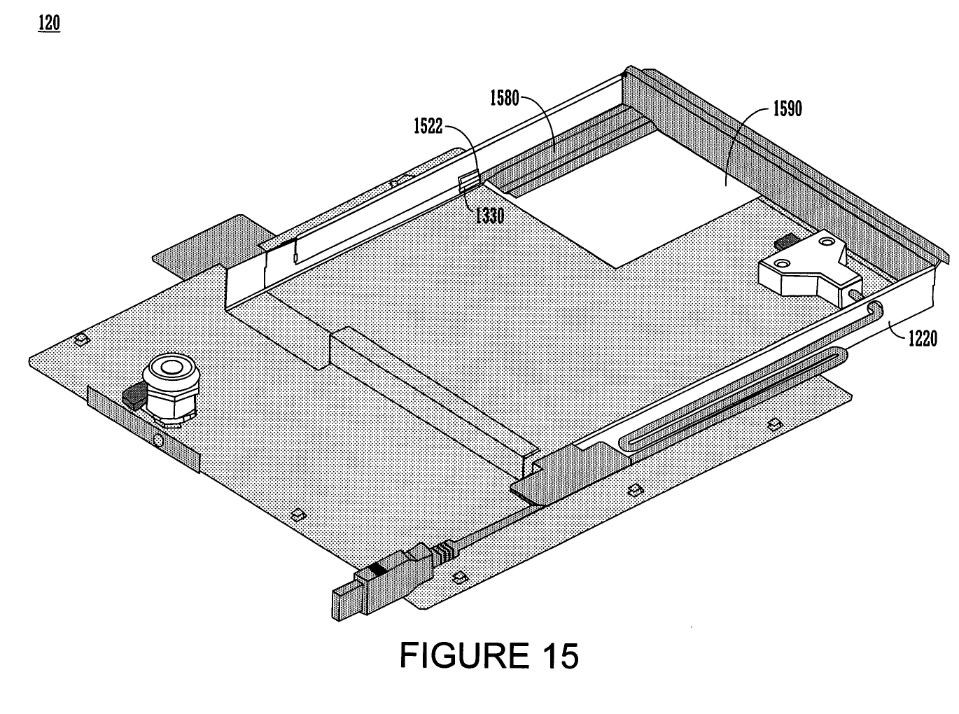

FIG. 15 shows a second perspective view of exemplary security device 120 with an exemplary external interface and an exemplary movement alert component in accordance with one embodiment of the present invention. As shown in FIG. 15, device 120 may comprise clip 1580 for securing item 1590. Clip 1580 may be formed from a single piece, or alternatively, be formed from multiple pieces. Additionally, portions of clip 1580 may be spring-loaded to hold down item 1590, where the spring may be a separate component and/or integrated within at least one component of clip 1580. Additionally, item 1590 may comprise a listing of passwords and/or usernames similar to item 590 of FIG. 5.

Although only one clip (e.g., 1580) is depicted in FIG. 15, it should be appreciated that device 120 may comprise more than one clip in other embodiments. Additionally, it should be appreciated that other components (e.g., 580 of FIG. 5) may be used in other embodiments to hold down items in addition to or in place of clip 1580. Further, although FIG. 15 depicts only one item held down by clip 1580, it should be appreciated that more than one item may be held down by clip 1580 in other embodiments.

As shown in FIG. 15, function element 1330 may be activated through hole 1522 in drawer 1220. For example, where element 1330 functions as a reset switch for movement alert component 1250, drawer 1220 may be pulled out of device 120 such that element 1330 may be depressed through hole 1522 to reset an activated alert. As such, in one embodiment, reset of an activated alert requires device 120 to be placed in an unsecured state (e.g., to allow drawer 1220 to be pulled out), thereby reducing the likelihood that an unauthorized person will disarm the alert and compromise items secured in device 120 (e.g., by transporting and/or tampering with device 120).

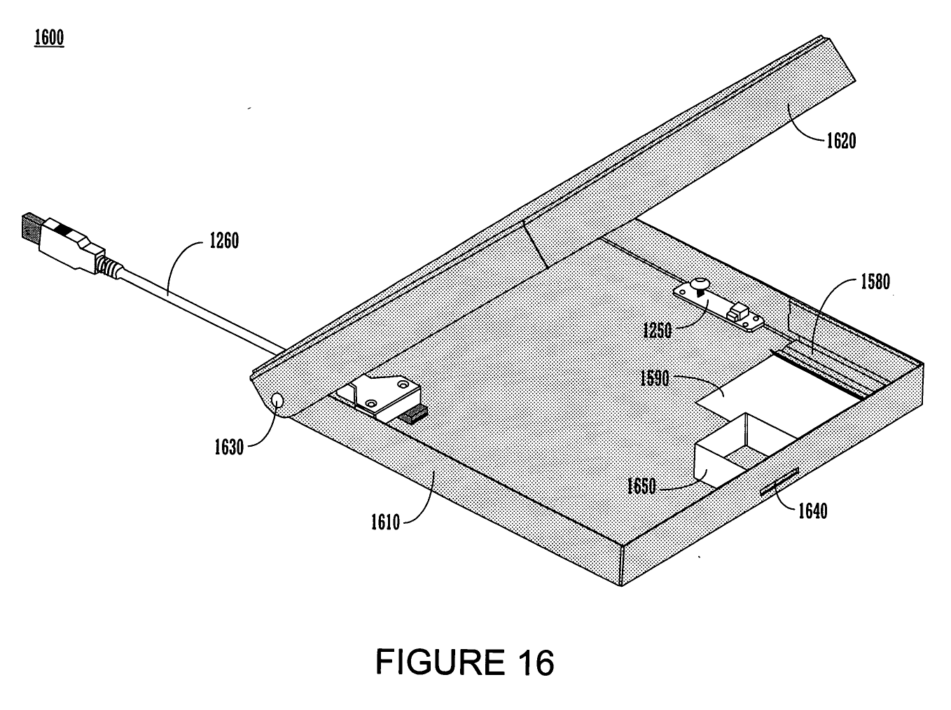

FIG. 16 shows a perspective view of exemplary security device 1600 in an unsecured state in accordance with one embodiment of the present invention. As shown in FIG. 16, security device 1600 comprises a bottom portion 1610 that is rotatably coupled to top portion 1620 via hinge mechanism 1630. When device 1600 is opened (e.g., by rotating top portion 1620 upward), bottom portion 1610 may receive items to be secured (e.g., similar to drawer 420 and/or drawer 1220 of device 120). Upon rotating top portion downward and closing device 1600, a lock mechanism (not shown in FIG. 16) coupled to top portion 1620 may be placed in a secured state to engage a lock arm (e.g., 540, 1240, etc.) of the lock mechanism (e.g., 122) with locking feature 1640, thereby limiting physical access to items stored in device 1600.

Similar to device 120, many different types of items may be secured within device 1600. For example, securable items may comprise portable computer systems, portable media devices, portable storage devices, password/username listings, etc, where the items may be organized by one or more item organizing features (e.g., hold-downs, clips, dividers, etc.). In one embodiment, device 1600 may comprise one or more clips (e.g., 1580) for holding down one or more items (e.g., 1590) similar to device 120. Additionally, device 1600 may comprise lock mechanism guard 1650 to reserve a space in bottom portion 1610 for the lock mechanism (e.g., 122), thereby reducing interference of the lock mechanism with items placed within bottom portion 1610 when device 1600 is being closed.

As shown in FIG. 16, device 1600 also comprises interface 1260 for coupling to secured items. As discussed above with respect to FIG. 12, one or more interfaces may be used to provide power to, communicate with, interact with, etc. an item secured within device 1600, thereby providing electrical access to the item while physical access is limited. As such, the security of the item, as well as the convenience of securing it, is increased by enabling it to remain in a secured state during use.

Movement alert component 1250 enables device 1600 to detect movement thereof, and generate an alert in response to the detected movement. Both movement detection and alert generation may be performed analogously to that of device 120 discussed above.

Although the lock mechanism has been described as coupling to top portion 1620, it should be appreciated that in other embodiments the lock mechanism may instead be coupled to bottom portion 1610 and locking feature 1640 may instead be located in top portion 1620. It should also be appreciated that the lock mechanism of device 1600 may comprise or otherwise be coupled to a switch (e.g., 124 of FIG. 1) capable of disabling and/or regulating signal throughput of an interface of a computer system (e.g., for coupling to computer peripherals as depicted in FIGS. 1 and 2, interface 1260, etc.), similar to that of device 120 discussed above. As such, the lock mechanism (e.g., 122) of device 1600 may be used to reduce unauthorized access to computer systems coupled to device 1600, peripheral devices coupled to device 1600, devices coupled to interface 1260, etc.

Additionally, although top portion 1620 and bottom portion 1610 of device 1600 have been described as rotating with respect to one another using a hinge mechanism (e.g., 1630), it should be appreciated that other coupling mechanisms (e.g., tab in slot, etc.) may be used in other embodiments to engage the end of device 1600 opposite that of the lock mechanism. Additionally, it should be appreciated that top portion 1620 may be removably coupled with bottom portion 1610 in other embodiments.

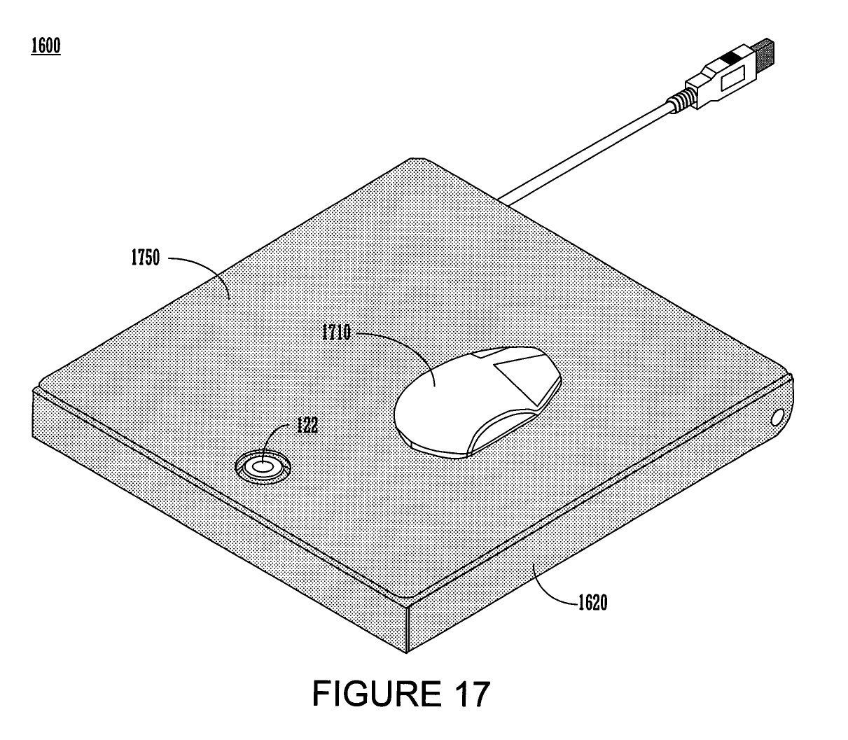

FIG. 17 shows a perspective view of exemplary security device 1600 in a secured state in accordance with one embodiment of the present invention. Once device 1600 is closed, top surface 1750 of top portion 1620 may be used with a peripheral device 1710 to interact with a coupled computer system. In one embodiment, surface 1750 may be substantially flat such that peripheral device 1710 (e.g., a computer mouse, other cursor directing devices, etc.) can be moved across the surface. Additionally, in one embodiment, lock mechanism may be recessed from surface 1750 such that the lock mechanism does not interfere with the movement of peripheral device 1710 across surface 1750.

It should be appreciated that surface 1750 may be coated such that the peripheral device (e.g., optical mice, laser mice, etc.) is able to track its movement across surface 1750. Similarly, it should be appreciated that an additional object (e.g., a rubber pad) may be placed on top of surface 1750 to further customize the surface for interface with peripheral devices. Additionally, the peripheral device may be coupled with a switch of device 1600 (e.g., similar to switch 124 of device 120) such that unauthorized access to a coupled computer system via the peripheral device may be conveniently limited (e.g., by changing the state of lock mechanism 122) as discussed above with respect to FIG. 16.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A computer chassis comprising:
a housing for enclosing computer electronics, said housing comprising a compartment for securing an item therein; and
a lock mechanism for placing said computer chassis in a secured state, said lock mechanism further for limiting physical access to said item when in said secured state.

2. The computer chassis of claim 1 further comprising a hard disk drive bay, and wherein said compartment is disposed within said hard disk drive bay.

3. The computer chassis of claim 1 further comprising an optical drive bay, and wherein said compartment is disposed within said optical drive bay.

4. The computer chassis of claim 1 further comprising:
a member for covering said compartment and engaging said lock mechanism, said member further for limiting physical access to said item when in said secured state.

5. The computer chassis of claim 1, wherein said item is selected from a group consisting of a portable computing system and a portable media device.

6. The computer chassis of claim 1, wherein said item comprises a portable storage device.

7. A computer chassis comprising:
a housing for enclosing computer electronics, said housing comprising a compartment for securing an item therein;
a lock mechanism for placing said computer chassis in a secured state, said lock mechanism further for limiting physical access to said item when in said secured state; and
an interface disposed at least partially within said compartment and for providing electrical access to said item when in said secured state.

8. The computer chassis of claim 7 further comprising a hard disk drive bay, and wherein said compartment is disposed within said hard disk drive bay.

9. The computer chassis of claim 7 further comprising an optical drive bay, and wherein said compartment is disposed within said optical drive bay.

10. The computer chassis of claim 7 further comprising:
a member for covering said compartment and engaging said lock mechanism, said member further for limiting physical access to said item when in said secured state.

11. The computer chassis of claim 7, wherein said interface enables communication with said item by an external device.

12. The computer chassis of claim 7, wherein said item is operable to be plugged into said interface.

13. The computer chassis of claim 7, wherein said interface provides power to said item for at least one of enabling operation of said item and charging a power source of said item.

14. The computer chassis of claim 7, wherein said interface enables transfer of media content accessed by said item.

15. The computer chassis of claim 7, wherein said interface enables transfer of data accessed by said item.

16. The computer chassis of claim 7, wherein said item is selected from a group consisting of a portable computing system and a portable media device.

17. The computer chassis of claim 7, wherein said item comprises a portable storage device.

18. A computer system comprising:
a chassis comprising:
a housing comprising a compartment, said compartment for securing an item therein; and
a lock mechanism for placing said compartment in a secured state, said lock mechanism further for limiting physical access to said item when in said secured state;
a processor disposed within said chassis; and
a memory disposed within said chassis.

19. The computer system of claim 18, wherein said computer chassis further comprises a hard disk drive bay, and wherein said compartment is disposed within said hard disk drive bay.

20. The computer system of claim 18, wherein said computer chassis further comprises an optical drive bay, and wherein said compartment is disposed within said optical drive bay.

21. The computer system of claim 18 further comprising:
a member for covering said compartment and engaging said lock mechanism, said member further for limiting physical access to said item when in said secured state.

22. The computer system of claim 18, wherein said item is selected from a group consisting of a portable computing system and a portable media device.

23. The computer system of claim 18, wherein said item comprises a portable storage device.

24. The computer system of claim 18 further comprising:
an interface disposed at least partially within said compartment and for providing electrical access to said item when in said secured state.

25. The computer system of claim 24, wherein said interface enables communication with said item by an external device.

26. The computer system of claim 24, wherein said item is operable to be plugged into said interface.

27. The computer system of claim 24, wherein said interface provides power to said item for at least one of enabling operation of said item and charging a power source of said item.

28. The computer system of claim 24, wherein said interface enables transfer of media content accessed by said item.

29. The computer system of claim 24, wherein said interface enables transfer of data accessed by said item.
